(19) United States
(12) Patent Application Publication
(10) Pub. No.: US 2015/0013845 A1
(43) Pub. Date: Jan. 15, 2015

(54) HOT-ROLLED STRIP FOR PRODUCING AN ELECTRIC STEEL SHEET AND METHOD THEREFOR

(71) Applicant: SALZGITTER FLACHSTAHL GMBH, 38239 SALZGITTER (DE)

(72) Inventors: Zacharias Georgeou, Wolfsburg (DE); Alexander Redenius, Braunschweig (DE)

(21) Appl. No.: 14/377,396

(22) PCT Filed: Jan. 30, 2013
(86) PCT No.: PCT/DE2013/000084

§ 371 Date: Aug. 7, 2014

(30) Foreign Application Priority Data
Feb. 8, 2012 (DE) 10 2012 002 642.0

(51) Int. Cl. C21D 8/12; B21B 15/00; H01F 1/147; C22C 38/28; C22C 38/06; C22C 38/02; B21B 1/46; C22C 38/32

(52) U.S. Cl. CPC C21D 8/1272; B21B 1/46; B21B 1/466; B21B 15/00; C21D 8/1211; C21D 8/1233; C22C 38/32; C22C 38/28; C22C 38/06; C22C 38/02; H01F 1/14791; B21B 2015/0057; B21B 2015/0064
USPC 148/111; 72/199; 72/203; 72/146; 72/128; 72/201; 420/79; 420/78; 148/309

(57) ABSTRACT

A hot strip for producing an electric steel sheet has the following alloy composition in weight %: C: 0.001 to 0.08 Al: 4.8 to 20 Si: 0.05 to 10 B: up to 0.1 Zr: up to 0.1 Cr: 0.1 to 4, remainder iron and melting related impurities.

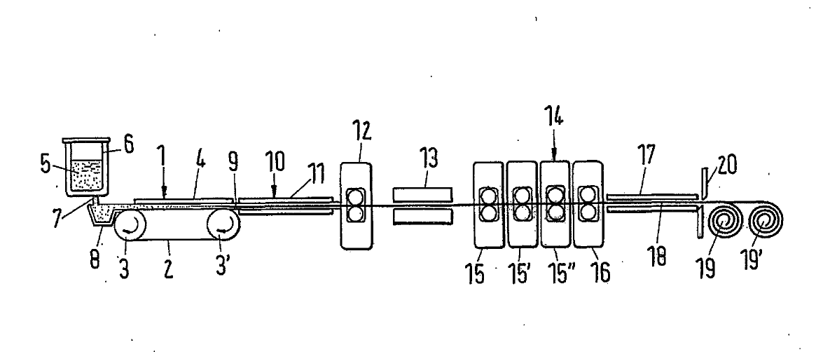

The invention relates to a hot strip for producing an electric steel sheet and a method therefore.

Materials for electric steel sheets are for example known from DE 101 53 234 A1 or DE 601 08 980 T2. They are mostly made of an iron silicone or iron silicone aluminum alloy, wherein a distinction is made between grain oriented (KO) and non-grain-oriented (NO) electric steel sheets, which are used for different applications. Aluminum and silicone are in particular added in order to keep the magnetization losses as low as possible.

Generally materials whose physical properties depend on the direction of load are referred to as anisotropic. When the properties are the same in all directions of load the materials are referred to as isotropic. The anisotropy of the magnetic properties of electric steel sheet is based on the crystal anisotropy of the iron. Iron and its alloys crystallize in a cubic structure. The cube edge direction is the direction, which can be magnetized the easiest [100]. The direction of the spatial diagonal [111] in the cube is the magnetically most unfavorable direction.

For applications in the electric machine construction in which the magnetic flux is not restricted to a defined direction and therefore good magnetic properties are demanded in all directions, electric steel sheet is usually produced with properties that are as isotropic as possible which is referred to as non-grain-oriented (NO) electric steel sheet. This is predominantly used in generators, electric motors, contactors, relays and small transformers.

The ideal structure (microstructure) for a non-grain-oriented electric steel sheet is a poly-crystalline microstructure with grain sizes between 20 μm and 200 μm wherein the crystallites are randomly oriented in the sheet plane with the surface (100). In praxis however the magnetic properties of real non-grain-oriented electric steel sheet in the sheet plane depend to a small degree on the magnetizing direction. Thus the loss differences between longitudinal and transverse direction are maximally only 10%. The establishment of a sufficient isotropy of the magnetic properties in non-grain-oriented electric steel sheet is significantly influenced by the configuration of the production process hot forming, cold forming and final annealing.

For applications that rely on a particularly low re-magnetization loss and in which particularly high demands are placed on the permeability or polarization, such as power transformers, distribution transformers and high performance small transformers, electric steel sheet is produced with a uniform orientation of the crystals (crystallographic texture) which is referred to as grain-oriented (KO-) electric steel sheet. The uniform orientation of the crystals causes a strong anisotropic behavior of the electric steel sheet. This is achieved in the complex manufacturing of the grain-oriented electric steel sheet by an effective grain growth selection. It's grains (crystallites) show an almost ideal texture with a low degree of misorientation in the final annealed material, the so-called Goss-texture named after its inventor. A cube edge points in rolling direction, a surface diagonal points transverse to the rolling direction. The deviation of the cube edge from the rolling direction in the standard material is usually 7° and in highly permeable material up to 3°. The size of the grains is several millimeters up to centimeters.

According to the known state of the art, important factors that determine the magnetic properties in the electric steel sheet are a high purity level, the content of silicone and aluminum (up to about 4 weight %), small amounts of other alloy elements such as manganese, sulfur and nitrogen, as well as hot rolling, cold rolling and annealing processes. The common sheet thicknesses are in the range significantly below 1 mm for example 0.18 or 0.35 mm.

While the non-grain-oriented material has magnetic properties in the sheet plane that are as isotropic as possible and is therefore preferably used for rotating machines, a grain-orientation (texture) in the grain-oriented material is generated by multiple subsequent rolling and annealing treatments. As a result of this targeted introduction of anisotropy in the material, the re-magnetization losses decrease at corresponding magnetizing direction and the relative permeability number increases. Thus transformers can be produced with this textured material, which compared to non-grain-oriented material have a higher performance while at the time have a small size.

The material known from DE 101 53 234 A1 for a non-grain-oriented electric steel sheet has an alloy composition with C<0.02%, Mn≦1.2%, Si 0.1-4.4% and Al 0.1-4.4%. Different production methods such as thin slab casting or thin strip casting are described with which a hot strip can be produced.

A disadvantage of the known material is the respective low Si and Al contents of maximally 4.4% with which in many applications the magnetic permeability is not yet sufficiently high and the magnetization loss is not sufficiently low which has an adverse effect on the efficiency of the electric machines and with this their economic efficiency. The electric resistance of the steel increases with increasing Si and Al content. As a result the induced eddy currents and with this also the core losses are reduced.

A problem is that with increasing Si content above the known limits, casting with the known methods is made difficult or even impossible as a result of macro-segregation or bending of the slab or strip during solidification. Steel with Al-contents>2% forms an oxide (Al₂O₃) during the solidification at air, which is extremely hard and brittle and thus makes a casting and further processing impossible. Therefore the steel can only be further processed to sheets with elaborate process techniques such as vacuum induction melting of the basic alloy to blocks, subsequent electro slag remelt process for homogenization and purifying the slag and subsequent re-forging with as the case may be material removing processing. Above 3.5% Si the cold formability is no longer given due to the brittleness (set order state), while the hot forming is relatively unproblematic up to 4%. Because eddy current losses increase with the square of the finished strip thickness, a small final thickness should be achieved. Due to the brittleness, this path in the conventional route (slab, thin slab casting (CSP)) can only be realized with difficulties. In near-net-shape casting methods such as thin strip casting with correspondingly high cooling rates, critical order states can be avoided.

Known methods also have the disadvantage that the starting product has a very coarse grain and casting with casting powder is problematic due to the high Al-content of the ferritic steel. Casting powder can no longer be used at an Al content of the melt of above about 2% because aluminum reacts with the oxygen bound in the casting powder and thus forms aluminum oxides (see above).

An object of the invention is to set forth a hot strip for producing an electric steel sheet which as significantly improved magnetic properties compared to known electric steel sheets, in particular a higher magnetic permeability.

A further object is to set forth an improved and more cost-effective production method for this hot strip.

The hot strip according to the invention has the following alloy composition in weight %:

C: 0.001 to 0.08

Al: 4.8 to 20

Si: 0.05 to 10

B: up to 0.1

Zr: up to 0.1

Cr: 0.1 to 4

remainder iron and melting dependent impurities.

Addition of B and/or Zr up to the stated limit can advantageously contribute to the improvement of the hot rolling properties because the forming nitrides (BN, ZrN) or carbides (ZrC) become localized at the grain boundaries and improve the gliding at high temperatures (hot rolling temperatures). In order to achieve an effect, the minimal content for B should be 0.001% and for Zr 0.05%. It is also advantageous that the hot crack formation is also reduced by these additions.

Adding Cr of more than 01% up to maximally 4% can advantageously improve the ductility at room temperature without significantly adversely affecting the magnetic properties.

The hot strip with the alloy composition according to the invention is characterized by significantly improved magnetic properties in particular by a significantly higher magnetic permeability, as a result of which the range of applications of this material can be significantly increased with regard to energetic and economic aspects. In particular the maximal Al-content, which is significantly increased to 20% compared to known electric steel sheets, results in a significant increase of the electric resistance and with this a corresponding decrease of the remagnetization losses.

Because the hot strip is further processed, for example rolled, at temperatures above 400° C., high demands regarding protection against scaling are placed on the material. As a result of the exceptionally high contents of Al or Si a dense layer of Al₂O₃ or SiO₂ forms on the surface of the heated sheet, which effectively decreases or even prevents scaling of the iron in the steel. The thickness of the layer can be influenced by the temperature and the time of the annealing.

With increasing temperature and duration of the annealing the thickness of the layer increases. However, this scale layer should not exceed a thickness of 100 μm, better 50 μm, so that the layer does not adversely affect the weldability by detaching scale due the also increasing brittleness.

Even though the addition of Si above 0.05% is not strictly required, a further increase of the magnetic permeability can advantageously be achieved by adding higher amounts of Si. It is particularly advantageous when the addition of Si occurs in dependence on the Al contents. At Al contents of 4.8% to 8% the Si content should be between 2 and 5%, at Al contents of more than 8 to 15% between 0.05 and 4% and above 15% Al below 2% so that the material remains hot rollable.

For an economic production of such a hot strip with consistent qualities, a method according to the invention is used in which the melt is cast in a horizontal strip casting unit under calm flow to a pre-strip having a thickness in the range between 6 and 30 mm and is then rolled to hot strip with a deformation degree of at least 50%, at thicknesses of 0.9 and 6.0 mm. Prior to the hot rolling an annealing process at 800 to 1200° C. may be required.

It was shown that the minimal deformation degree to be used should also be increased with increasing Al content. Thus depending on the final strip thickness to be achieved and the Al content, deformation degrees of more than 50, 70 or even more than 90% have to be established in order to achieve a mixed microstructure of ordered and disordered phases. The high deformation degree is also required to destroy the microstructure, especially in the case of high Al alloys, to make the grains smaller (grain refinement). Higher Al contents therefore require correspondingly higher deformation degrees.

At a thickness of for example 0.9 mm the hot strip can also advantageously be used as final product in electromagnetic fields of applications. In order to obtain a strip with grain-oriented microstructure an additional annealing process is required to allow orientation of the grains. This process, which provides for an annealing treatment between 800 and 1200° C., can occur continuously or discontinuously and may last for up to 30 minutes. Thus it is possible with the alloy composition according to the invention to produce grain-oriented (KO) as well as non-grain-oriented (NO) electric steel sheets, depending on the demand.

In addition this creates the possibility to cold roll the hot strip after a reheating annealing (as the case may be in decarburizing atmosphere) and thereby establish final thicknesses of up to 0.1 mm. The annealing after the cold rolling should occur at temperatures of 700 and 900° C. for maximally 10 minutes or for KO electric steel sheets several hours in a comparable temperature window.

A decarburizing atmosphere is advantageous because it decreases the carbon content in the strip (mainly in the edge region). This leads to an improvement of the magnetic properties because fewer defects occur in the material, which are for example caused by the carbon atoms.

The advantage of the proposed method is that when using a horizontal strip casting system, macro-segregations and blowholes can be avoided to the most degree due to very homogenous cooling conditions in the horizontal strip casting unit. Because no casting powder is used in these systems, casting powder-related problems are not encountered.

The technique proposed to achieve the calm flow for the strip casting process is to use an electromagnetic brake, which produces a field which moves in synchrony with or at optimal relative speed to the strip, which ensures that in the ideal case the speed of the melt supply equals the speed of the rotating conveyor belt. The bending during the solidification, which is considered disadvantageous, is avoided in that the bottom side of the casting belt which receives the melt is supported on a multitude of adjacently arranged rolls. The support is enhanced in that in the region of the casting strip a vacuum is generated so that the casting strip is firmly pressed onto the rollers. In addition the Al-rich or Si-rich melt solidifies in an almost oxygen-free furnace atmosphere. In conventional routes above 1250° C. the Si-rich scale (Fayalite) liquefies which in addition can only be removed with difficulties. This can be avoided by a corresponding temperature time profile in the housing and the following process steps.

In order to maintain these conditions during the critical phase of the solidification, the length of the conveyor belt is selected so that at the end of the conveyor belt prior to its redirection the pre-strip is completely solidified to the most degree.

Adjoining the end of the conveyor belt is a homogenization zone, which is used for temperature compensation and possible tension reduction. The rolling of pre-strip to a hot strip can either occur in-line or separately off-line. Prior to the off-line rolling the pre-strip can be directly coiled hot or be cut to sheets after the production and prior to the cooling. The strip or sheet material is then reheated after a possible cooling and coiled for the offline rolling or reheated as sheet and rolled.

The included sole FIGURE schematically shows a method sequence according to the invention for the condition casting speed=rolling speed.

Upstream to the hot rolling process is the casting method with a horizontal strip casting system 1, composed of a revolving conveyor belt 2 and two deflection rollers 3, 3′. It can also be seen a side sealing 4 which prevents that the applied melt 5 runs off the conveyor belt on the left hand and right hand sides. The melt 5 is transported to the casting system 1 by means of a pan 6 and flows into a supply container 8 through an opening 7 arranged in the bottom. This supply container 8 is configured in the manner of an overflow container.

Not shown are the devices for intensive cooling of the bottom side of the upper tower of the conveyor belt 2 and the complete housing of the strip casting system 1 with corresponding protective atmosphere.

After applying the melt 5 onto the revolving conveyor belt 2 the intensive cooling cause the solidification and the formation of a pre strip 9, which is mostly completely solidified at the end of the conveyor belt 2.

For temperature compensation and tension reduction, a homogenization zone 10 is arranged downstream of the strip casting system 1. The latter is formed by a heat insulated housing 11 and a here not shown roller bed.

An intermediate heating device follows, preferably here configured as inductive heating for example in the form of a coil 13. The actual hot forming occurs in the downstream scaffold series 14, wherein the first three scaffolds 15, 15′, 15″ cause the actual reduction per pass while the last scaffold is configured as reeling mill.

After the last stich a cooling zone 17 follows in which the finished hot strip is cooled to coiling temperature.

Between the end of the cooling path 17 and coiling 19, 19′ a cutter 20 is arranged. This cutter 20 has the purpose to cut the hot strip transversely as soon as one of the two codlings 19, 19′ is fully coiled. The start of the following hot strip 18 is then guided onto the second freed reel 19, 19′. This ensures that the strip tension is maintained over the entire strip length. This is in particular important for the production of thin hot strips.

Not shown in the FIGURE are the system components for reheating the pre strip 9 prior to the hot rolling and for the cold rolling of the hot strip.

### LIST OF REFERENCE SIGNS

| Nr | designation |
|---|---|
| 1 | strip casting system |
| 2 | conveyor belt |
| 3, 3′ | deflection roller |
| 4 | lateral sealing |
| 5 | melt |
| 6 | pan |
| 7 | opening |
| 8 | supply container |
| 9 | Pre strip |
| 10 | homogenization zone |
| 11 | housing |
| 12 | first scaffold |
| 13 | induction coil |
| 14 | scaffold series |
| 15, 15′, 15″ | rolling scaffold |
| 16 | smoothening scaffold |
| 17 | cooling path |
| 18 | finished hot strip |
| 19, 19′ | reel |
| 20 | cutter |

1-23. (canceled)

24. A hot strip for producing an electric steel sheet having the following alloy composition in weight %:
C: 0.001 to 0.08
Al: 4.8 to 20
Si: 0.05 to 10
B: up to 0.1
Zr: up to 0.1
Cr: 0.1 to 4
remainder iron and melting related impurities

25. The hot strip of claim 24, having an Al content of 4.8% to 8% and a Si content of 2 to 5%.

26. The hot strip of claim 24, having an Al content of more than 8% and up to 15% and the Si content is up to 4%.

27. The hot strip of claim 24, having an Al content of more than 15% and up to 20% and a Si content of up to 2%.

28. The hot strip of claim 24, having a B-content of 0.001% up to 0.1% and/or an Zr-content of 0.05% up to 0.1%.

29. The hot strip of claim 24, having either a grain-oriented or non-grain-oriented microstructure.

30. A method for producing a hot strip for producing an electric steel sheet, comprising:
casting a melt in a horizontal strip casting system under calm flow and free of bending to form a pre-strip having a thickness in the range between 6 and 30 mm, said melt having the following alloy composition in weight %:
C: 0.001 to 0.08
Al: 4.8 to 20
Si: 0.05 to 10
B: up to 0.1
Zr: up to 0.1
Cr: 0.1 to 4;
remainder iron and melting related impurities; and
rolling the pre-strip to a hot strip with a deformation degree of at least 50%.

31. The method of claim 30, wherein the melt is supplied at a speed equaling a speed of a revolving conveyor belt of the horizontal strip casting system.

32. The method of claim 30, wherein for all surface elements of the strand shell which form with the solidification of a band which extends across the width of the conveyor belt approximately the same cooling conditions are given.

33. The method of claim 30, wherein the melt applied onto the conveyor belt is substantially fully solidified at an end of the conveyor belt.

34. The method of claim 33, wherein after full solidification and prior to starting a further processing, the pre-strip is passed through a homogenization zone.

35. The method of claim 34, wherein the further processing comprises cutting the pre-strip to sheets.

36. The method of claim 35, further comprising after cutting the pre-strip to sheets, heating the sheets to a rolling temperature and subjecting the sheets to the rolling process.

37. The method according to claim 34, wherein the further processing comprises a coiling of the pre-strip.

38. The method of claim 37, further comprising de-coiling the pre-strip after the coiling, heating the pre-strip to rolling temperature, and subjecting the pre-strip to a rolling process.

39. The method of claim 37, further comprising reheating the pre-strip prior to the de-coiling.

40. The method of claim 30, wherein the pre-strip is subjected to the rolling process in-line and is subsequently coiled.

41. The method of claim 30, wherein the deformation degree during rolling is >70%.

42. The method of claim 30, wherein the deformation degree during rolling is >90%.

43. The method of claims 30, further comprising reheating the hot strip in an annealing process and cold rolling the hot strip after the cooling.

44. The method of claim 43, wherein the hot strip is annealed in the annealing process in a decarburizing atmosphere.

45. The method of claim 43, wherein the hot strip is cold rolled to a maximal thickness of 0.150 mm.

46. The method of claim 43, further comprising after the cold rolling, annealing the cold rolled strip so as to establish a grain-oriented microstructure in the cold rolled strip.
